(19) United States
(12) Patent Application Publication
(10) Pub. No.: US 2010/0222002 A1
(43) Pub. Date: Sep. 2, 2010

(54) RADIO-COMMUNICATION MODULE COMPRISING EMISSION MEANS CONTROLLED BY INTERFERENCE DETECTION MEANS AND CORRESPONDING DEVICE AND USE

(75) Inventor: Thierry Lys, Paris (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Wavecom, Issy-Les-Moulineaux Cedex (FR)

(21) Appl. No.: 12/160,927

(22) PCT Filed: Jan. 15, 2007
(86) PCT No.: PCT/EP2007/050354

§ 371 Date: Oct. 15, 2008

(30) Foreign Application Priority Data
Jan. 16, 2006 (FR) 0600381

(51) Int. Cl. H04B 15/00

(52) U.S. Cl. 455/63.1

(57) ABSTRACT

A radiocommunication module is provided, which includes a transmitter with a first mode of communication in at least one first frequency band. The module also includes: an interference detector for emitting a warning signal if interference is detected; and a controller for controlling the transmitter in such a way that it is able to switch between the first mode of communication and a second mode of communication which is different from the first mode, if the interference detector emits the warning signal.

### CROSS-REFERENCE TO RELATED APPLICATIONS

This application is a Section 371 National Stage Application of International Application No. PCT/EP2007/050354, filed Jan. 15, 2007 and published as WO 2007/080190A1 on Jul. 19, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

This disclosure relates to the field of radio-communications and more especially that of radio-communication devices comprising a radio-communication electronic module, such as radio-telephones, personal digital assistants, automobile navigation systems, etc. The above-mentioned radio-communication module complies with a radio-communication standard notably such as, but not exclusively, the GSM (Global System for Mobile), the GPRS (Global Packet Radio Service); the UMTS (Universal Mobile Telecommunications System), the WCDMA (Wideband Code Division Multiple Access), the WiFi (Wireless Fidelity), the Bluetooth standard, etc.

More precisely, the disclosure relates to the techniques of controlling the transmission means in such devices, using two distinct modes of communication.

Usually, for a cellular radio-communication device, the transmission means of this type of device are incorporated into the radio-communication module (also called GSM module in the following description).

### BACKGROUND OF THE DISCLOSURE

We will discuss below the disadvantages of the prior art using the example of a GSM module incorporated into an automobile on-board computer.

More and more automobiles are stolen each year. To combat this epidemic, the equipment suppliers offer the users a GSM module to be dissimulated in their vehicle which allows them to have access to the usual GSM telephone services and also to the new “tracking” services using the GSM network. These tracking services using the GSM network permit a stolen vehicle to be identified, located and possibly immobilised remotely.

In the event of a warning signal being received by a tracking centre, this first type of GSM module usually uses communications which use the GSM standard, to transmit (for example in SMS form—short message service) specific information (also called pursuit information) which permits the vehicle to be identified and/or located.

More precisely and as shown in FIG. 1, the usual transmission chain of a GSM module 100 comprises a storage unit 1 which contains pursuit information (or identification information). This pursuit information may contain for example the features of the stolen vehicle (registration plate, type and colour of the vehicle, etc.) or a warning message, designed to be broadcast permanently so as to determine the position of the stolen vehicle in a constellation of BTS base stations (Base Transceiver Stations).

A processing unit 2 (generally called baseband chipset) connected to the storage unit 1 processes the pursuit information, modulates them and generates a modulated base band output signal 3.

The modulated base band signal 3 is then transmitted to a frequency transposition unit 4 (also called transmitter/receiver unit or transceiver in the rest of the document).

The frequency transposition unit 4 is followed by a power amplifier 6 (PA) which amplifies the signal 5 output from the frequency transposition unit 4.

The signal 7 (containing the pursuit information) generated by the power amplifier 6 is transmitted by an antenna 8.

One of the failings of this first type of GSM to pursue vehicles is the use of interfering transmitters (or jammers).

Indeed, car thieves now have GSM jammer which, once activated, cause random operation or failure of the pursuit system, as the GSM is no longer synchronised with the tracking centre. Consequently the GSM module is no longer able to exchange alarm information with the centre.

For the sake of clarity, in the rest of the document we will call “GSM mode” the mode for the use of usual GSM communications (also called first mode) and “beacon mode” the mode for the use of communications dedicated to the pursuit of stolen vehicles (also called second mode).

To overcome this problem, usually it is envisaged to associate a GSM module and an auxiliary radio-communication module; the GSM module is solely used for the GSM mode and the auxiliary radio-communication module for the beacon mode. This auxiliary radio-communication module permits the use of communications using a non-GSM communication standard (which is to say other than GMSK modulation) in a frequency band selected outside of the GSM frequency range.

As illustrated in FIG. 2, this solution of the prior art consists of grouping the GSM module 100, already described in relation to FIG. 1, and an auxiliary radio-communication module 200 in a same casing 300, thus forming a hybrid radio-communication module. Placing these two modules in parallel thus permits the pursuit system to be made stronger. Indeed, the presence of GSM jammer causes the GSM module 100 to dysfunction, however the transmission/reception functions of the auxiliary radio-communication module 200 are unaltered, as the latter does not operate in the GSM bands, and more particularly operates in the ISM bands (Industrial Scientific medical bands). The auxiliary radio-communication module 200 comprises a reception unit 201 which provides it with the capacity to receive at a determined frequency, via an antenna 203, warning signals from a tracking centre, and a transmission unit 202 which provides it with the capacity to transmit, via the antenna 203, pursuit signals according to a communication standard.

Even though the hybrid radio-communication module was a major step forward in tracking stolen vehicles, the second known type of GSM module nevertheless has the disadvantages of being large and costly due to the duplication of the transmission means.

There is consequently a need to optimise the control of the transmission means of a radio-communication module, especially for the implementation of two distinct modes in a same radio-communication device, which does not require the transmission unit (power amplifier, filters, antenna, etc.) to be doubled.

### SUMMARY

An aspect of the disclosure relates to a radio-communication module comprising transmission means with a first communication mode in at least one first frequency band.

According to an embodiment of the invention, the radio-communication module further comprises:
interference detection means of said module, permitting an alarm signal to be sent if interference is detected;
means of controlling said transmission means, permitting to switch from said first mode to a second communication mode that is distinct from the first mode, in at least one second frequency band, if said interference detection means supply said alarm signal.

Therefore an embodiment of the invention is based on an entirely novel and inventive approach for controlling the transmission means in a radio-communication device. Indeed, an embodiment of the invention proposes automatic switching of the transmission means from a first mode to a second communication mode, wherein each mode operates in a distinct frequency band.

For this purpose, interference detection means are used which permit, during the operation of the transmission means in the first communication mode, to check for the presence of an interference signal in the frequency band of the first mode, so as to activate the control means, for example if the interference signal level is greater than or equal to a predetermined noise level.

Furthermore, the generation of a clear command to switch the transmission means to the second mode, permits the false alarm errors to be restricted as well as the electrical consumption of the module, as only one of these modes is active at any given time.

If the interference detection means according to an embodiment of the invention may be implemented externally from the module, they will be preferably incorporated into the latter. Indeed, in this case they are easy to implement and provide improved ergonomics.

In one advantageous aspect of an embodiment of the invention, said second communication mode uses at least one second frequency band that is distinct from said at least one first band.

Preferably, said at least one first band is a GSM band 880.2-914.8 MHz, and said at lest one second band is an ISM band 915-925 MHz.

Advantageously, the first communication mode complies with a radio-communication standard belonging to the group comprising the GSM, GPRS, UMTS, WCDMA, WiFi, Bluetooth, etc.

Preferably, the second communication mode implements a modulation technique belonging to the group comprising:
digital modulation techniques of the OOK type;
digital modulation techniques of the FSK type.

In one preferred embodiment of the invention, said transmission means comprise an amplifier which receives an input signal, supplies an output signal and is controlled by a command signal. Furthermore, in said second communication mode, the input signal is a non-modulated signal and the command signal is a binary modulation signal, whose upper and lower levels respectively permit the activation and deactivation of the amplifier, or inversely such that the output signal is a signal modulated by a digital OOK type modulation technique.

It should be stated that by non-modulated signal, it is meant a continuous signal or CW (continuous wave), which is to say a signal with constant amplitude and frequency.

Consequently, it is possible to modify the power supply to the amplifier (i.e. its enable input) to generate at its output a signal that can switch between upper and lower logic levels and inversely. For example, the upper logic level is obtained when the amplifier is powered, in return, when the amplifier is not powered (i.e. when a lower logic level is applied to the enable input), it does not send an output signal, wherein this absence of signal corresponds to a lower logic level.

Advantageously, said transmission means comprise a switch between the amplifier and an antenna. Furthermore, in said second communication mode, the switch is controlled by said command signal so that the antenna only receives the output signal from the amplifier if the amplifier is activated by said command signal.

An embodiment of the invention therefore proposes a switch to decorrelate the upper and lower logic levels, to which the signals (or the absence of signals) output from the amplifier correspond. Consequently, in the second mode, it is possible to obtain simply an isolation of around 60 dB between the two logic levels transmitted by the antenna. This principle permits the isolation of the OOK modulation to be increased substantially.

Preferably, said control means comprise digital processing means and memory means, containing data to control and command said digital processing means, on the one hand according to said first communication mode and on the other hand according to said second communication mode.

Advantageously, said control means further permit to switch from said second to first communication mode in the case of the verification of at least one condition belonging to group comprising:
a detection by said detection means of the end of interference of said module;
a predetermined time has passed since the detection of interference of said module;
an end of alarm signal is received via the first reception means which operate with said module or are incorporated into said module.

Preferably, said interference detection module comprise second means for receiving an activation signal from said first reception means which operate with said module or are incorporated into said module.

an embodiment of this invention covers the case in which the interference detection means are placed in a stand-by mode until an activation signal is received. It is thus possible to reduce the electrical consumption of the module during the period of operation of the transmission means.

In one preferred embodiment of the invention, said radio-communication module is designed to be mounted inside a vehicle, wherein said second communication mode is used to transmit information permitting said vehicle to be identified and/or located via a vehicle tracking network.

An embodiment of the invention also relates to the use of a radio-communication module, wherein said radio-communication module is mounted inside a vehicle, and said second radio-communication mode is used to transmit information permitting said vehicle to be identified and/or located via a vehicle tracking network.

An embodiment of the invention also relates to a radio-communication device comprising at least one radio-communication module comprising transmission means with a first communication mode in at least one first frequency band, wherein the device comprises:
means of detecting the interference of said module, permitting an alarm signal to be sent if interference is detected;
means of controlling said transmission means, permitting to switch from said first mode to a second communication mode, distinct from the first mode, if said interference detection means send said alarm signal.

### BRIEF DESCRIPTION OF THE DRAWINGS

Other features and advantages will become clearer upon reading the following description of a preferred embodiment of the invention, provided purely by way of illustration and in no way restrictively, and of the appended drawings, among which:

FIG. 1, already described in relation to the prior art, shows the simplified diagram of a standard radio-communication module;

FIG. 2, also described in relation to the prior art, shows the simplified diagram of a hybrid radio-communication module comprising the module of FIG. 1 and an auxiliary radio-communication module;

FIG. 3 shows the simplified diagram of a radio-communication module according to a preferred embodiment of the invention;

FIG. 4 shows a block diagram of one specific embodiment of the operation of the module of FIG. 3; and

FIGS. 5A and 5B show two examples of the ISM frequency band, adapted to the second communication mode according to an embodiment of the invention, respectively in Europe and the USA.

### DETAILED DESCRIPTION OF ILLUSTRATIVE EMBODIMENTS

The general principle of an embodiment of the invention is based on the automatic switching of transmission means from a first mode to a second mode of communication, from a signal that is representative of information on the presence of interference.

According to an embodiment of the invention, a control mechanism comprises detection means, which permit interference to be detected in a GSM frequency band and where applicable to control the switching of the transmission means to the second mode. This control mechanism permits the same transmission means to be used in the two communication modes, to reduce the size of the module.

It may be noted on all of the figures in this document that identical elements have the same numerical reference.

The ISM bands are frequency bands that may be used for industrial, scientific and medical applications.

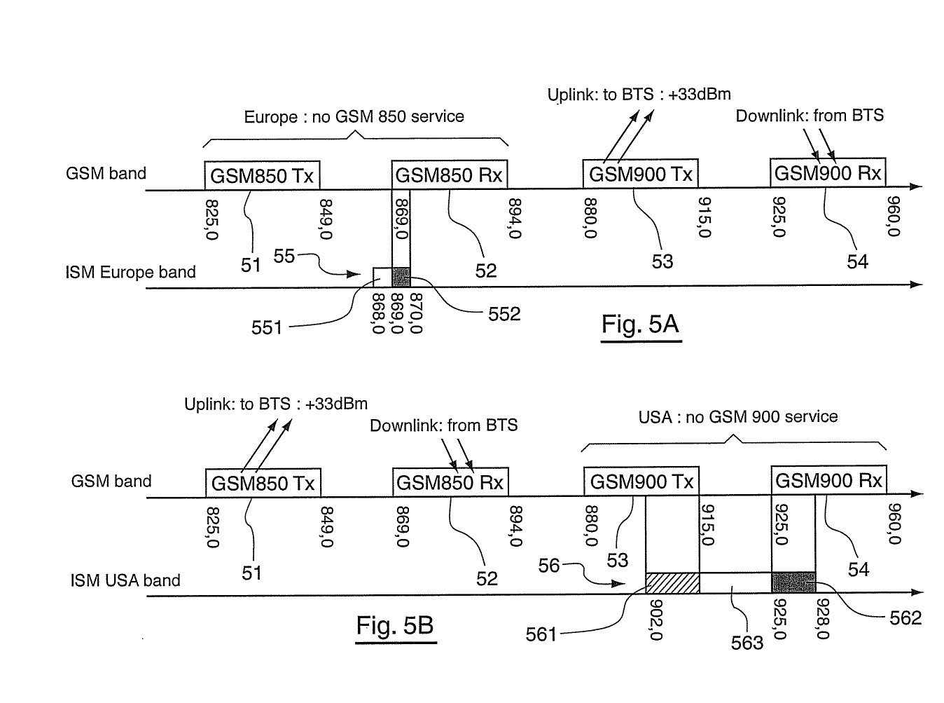

FIGS. 5A and 5B illustrate two examples of ISM frequency bands adapted for the implementation of communications in the second mode (beacon mode) in Europe (FIG. 5A) and in the USA (FIG. 5B).

As illustrated in FIG. 5A, in Europe the ISM 55 band is between 868 and 870 MHz. The portion 552 of the ISM band which extends from 869 to 870 MHz coincides with the GSM 850Rx 52 band, reserved for the reception of GSM communications between 869 and 894 MHz. Even though the GSM 850 51 and 52 is not used in Europe, it may be easily disrupted by a GSM jammer (interfering device). In Europe, the portion 551 of the ISM band may therefore be used, which extends between 868 and 869 MHz to implement the second communication mode based on a digital modulation technique of the OOK, FSK, etc. type.*

As illustrated by FIG. 5B, in the USA the ISM band 56 extends between 902 and 928 MHz. The portion 562 of the ISM band which extends between 925 and 928 MHz coincides with the GSM 900Rx 54 band, reserved for the reception of GSM communications between 925 and 960 MHz. Furthermore, the portion 561 of the ISM band which extends between 902 and 915 MHz coincides with the GSM 900Tx 53 band, reserved for the reception of GSM communications between 880 and 915 MHz. Even though the GSM 900 53 and 54 band is not used in the USA, it may be easily disrupted by a GSM jammer. In the USA, it may be observed that it is possible to use the portion 563 of the ISM band, which extends between 915 and 925 MHz to operate the radio-communication module in the second communication mode.

To simplify the description, the rest of the document will only refer to the specific case of a radio-communication module implementing, in the second communication mode, an OOK type modulation technique in an ISM 915-925 MHz frequency band.

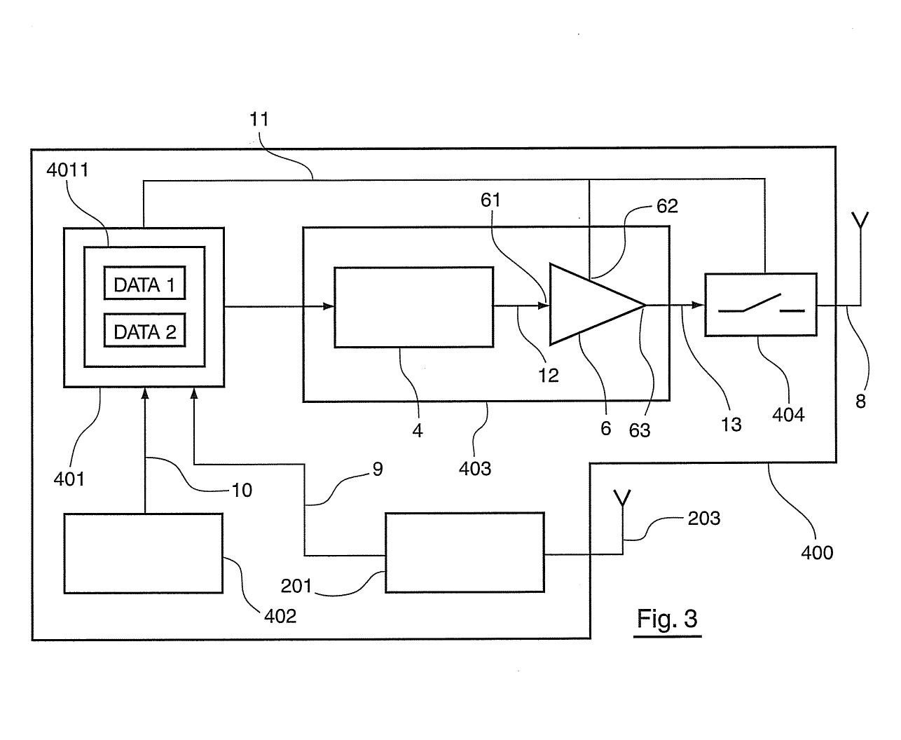

In relation to FIG. 3, we will now describe a radio-communication module 400 according to a preferred embodiment of the invention.

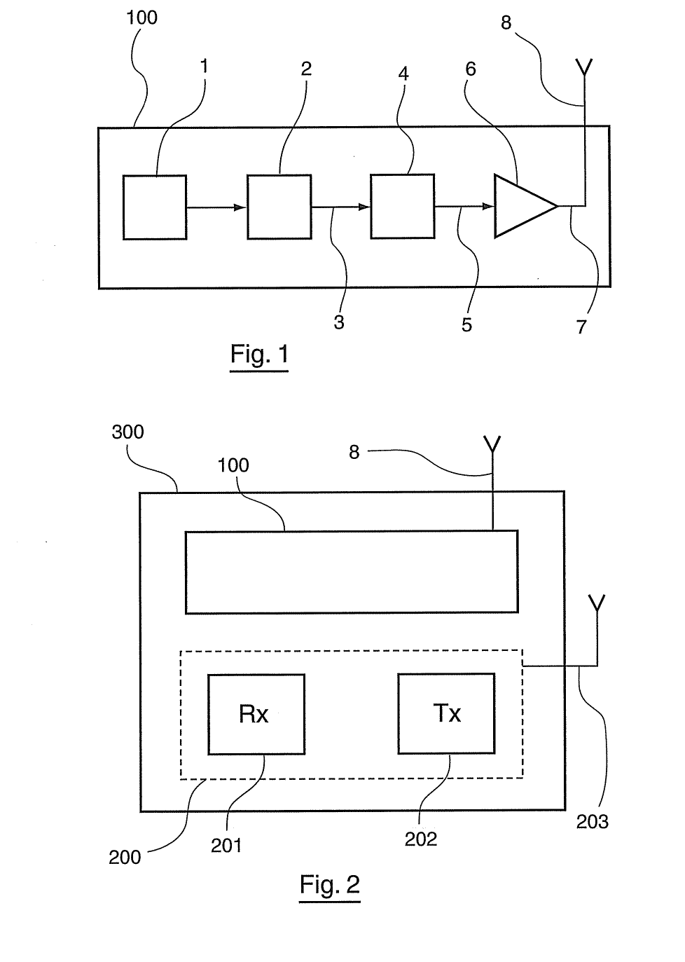

In this embodiment, the radio-communication module 400 according to the invention comprises:
means of detecting interference 402 and control means 401 specific to an embodiment of the invention;
a switch 404 specific to an embodiment of the invention; and
standard type transmission means 403 (of which the operation has already been described in relation to FIG. 1);

The control means 401 comprise a memory 4011 in which the first DATA1 and second DATA2 information are stored for controlling the transmission means 403.

As we will see in the following description, this first DATA1 and second DATA2 command data permits the transmission means 403 to implement respectively a first (GMSK modulation) and second (OOK modulation) communication mode.

In further detail, first reception means 201 receive, via an auxiliary antenna 203, a warning signal (not shown) from a tracking centre and send an activation signal 9.

The activation signal 9 is then transmitted to the control means 401.

Consequently, the reception of the activation signal 9 permits the control means 401 to switch the interference detection means 402 from a stand-by mode (which permits the detection means to be deactivated to reduce the electrical consumption of the module) to an active mode, wherein the presence of an interference signal is verified in the GSM frequency band of the first mode (for example between 880 and 914.8 MHz.

In FIG. 3, the interference detection means are illustrated in the form of an operational unit reference 402.

Usually, interference detection means 402 may be in hardware and/or software form. In the case of a software implementation, the interference detection means are, for example, implemented in the control means 401.

When the interference detection means 402 detect an interference signal, they generate an alarm signal 10. This alarm signal 10 is then sent to the control means 401.

Initially, the control means 401 read the second control data DATA2 stored in the memory 4011.

Subsequently, the control means 401 generate a command signal 11 and place the transceiver 4 in a mode, in which it supplies a non-modulated signal 12. As already stated, the command signal 11 is a binary modulation signal and the non-modulated signal 12 is a signal with constant amplitude and frequency, for example 915 MHz.

The non-modulated signal 12 is then applied to the input 61 of the amplifier 6 and the command signal 11 to its enable input 62. Consequently, the upper and lower levels of the command signal 11 respectively permit the amplifier 6 to be activated and deactivated, so that the output signal 13 is a signal modulated by an OOK type modulation technique.

It should be noted that the switch 404 mounted between the amplifier 6 and the GSM antenna 8 is also controlled by the command signal 11, so that the upper and lower levels of the command signal 11 respectively permit the switch to be closed and opened. The stats of the amplifier (activated/deactivated) and the switch (closed/open) are synchronised so that when the command signal 11 is at the high level, the GSM antenna 8 receives the output signal 13 from the amplifier (amplifier activated and switch closed), in return, when the command signal 11 is at the lower level, the GSM antenna 8 does not receive a signal.

In the beacon mode (second communication mode), the GSM antenna 8 emits a signal when the switch 404 is in a closed state, wherein the transmission of a signal corresponds to an upper logic level “1”, in return, when it is in an open state the GSM antenna does not emit a signal, and the non-transmission of signals corresponds to a lower logic level “0”. Consequently an OOK type modulation is obtained, according to which the information are not carried by the amplitude but by the difference between the two logic levels “0” and “1”. It may further be noted that the isolation between the upper “1” and lower “0” logic levels is created by the switch 404.

In one preferred embodiment of the invention, the transmission means switch from the beacon mode to the GSM mode when the first reception means receive an end of alarm signal from a tracking centre.

In one variant of the embodiment, it may be envisaged that the transmission means switch from the beacon mode to the GSM mode when the detection means detect an end of interference of the radio-communication module.

In another variant of the embodiment, it may also be envisaged to return to the GSM mode after verification of a double condition, for example that a predetermined period of time has passed and that an end of interference has been detected.

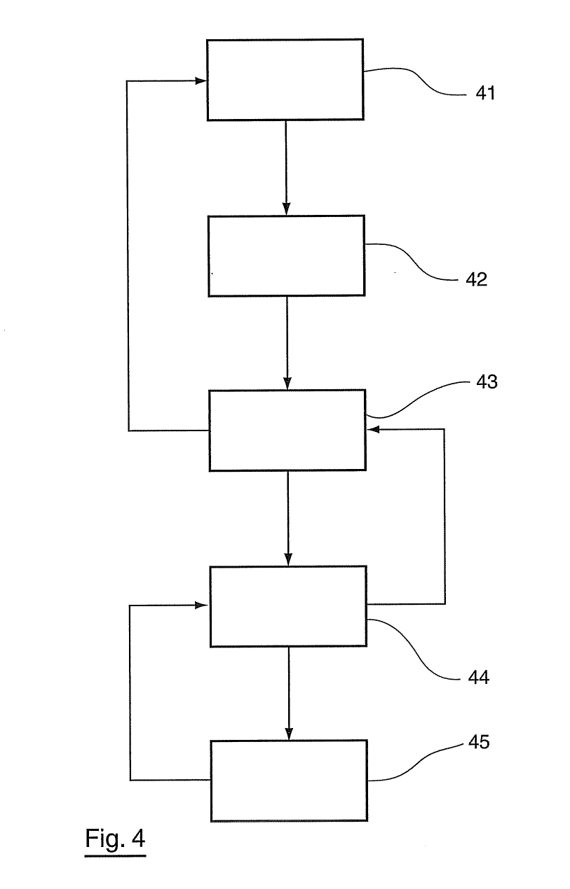

FIG. 4 illustrates the successive sequence of the various operating steps.

One operating phase in GSM mode comprises a first step 41, in which the control means 401 read the first command data DATA1 stored in a memory 4011. In this step, the control means 401 control the transmission means 403 so that they implement communications according to a GMSK type modulation technique in the GSM 880-914.8 MHz frequency band. The first command data DATA1 further permits the switch 404 to be maintained in a closed state, so as to authorise the transmission/reception of data via the GSM antenna 8.

It is important to note that in the absence of interference in the GSM frequency band, the transmission means may also be used in the GSM mode to transmit pursuit signals to a tracking centre in the case of a vehicle being stolen.

A reception phase comprises a step 42 in which first reception means 201 receive, via the auxiliary antenna 203, an alarm signal from a tracking centre, indicating the theft of the vehicle.

An interference detection phase comprises a step 43 in which the interference detection means 402 verify the presence of an interference signal in the GSM 880-914.8 MHz frequency band.

If no interference signal is detected, then the system returns to step 41 or passes to a step 44.

An operating phase in beacon mode comprises a step 44, in which the control means 401 read the second command data DATA2 stored in the memory 4011. In this step, the control means 401 control the transmission means 403 so that they implement communications according to an OOK type modulation technique in the ISM 915-925 MHz frequency band.

Finally, in step 45, a verification is made that a predetermined time period has passed since the detection of the interference signal in step 43.

If the predetermined time period has passed, then the system returns to step 43 or passes to the step 44.

In summary, the radio-communication module as proposed by an embodiment of the invention has many advantages, of which a non-restrictive list is provided below:
improvement of the size, indeed an embodiment of the invention permits the same transmission means to be used in two distinct communication modes;
improvement of the cost, indeed an embodiment of the invention permits the redundant transmitter to be eliminated.

Of course, the invention is not restricted to the embodiment mentioned above.

In particular, the memory means (memory 4011) may be implemented in any other manner, which is to say in particular externally from the control means.

In general, in other embodiments, the values of the GSM and ISM frequency bands may be different from those mentioned in the preferred embodiment mentioned above.

An embodiment of the invention provides a technique, which permits the simple and efficient implementation of two communication modes that are totally different, using the same transmission means.

An embodiment of the invention proposes such a technique, which permits a switch from the first mode to the second mode when an interference signal is detected.

An embodiment of the invention provides such a technique, which does not require the attribution of new frequency bands.

An embodiment of the invention provides such a technique, which, in at least one embodiment, permits a radio-communication module to be created at a reasonable cost, with acceptable compactness and ergonomics.

An embodiment of the invention provides such a technique which, in at least one embodiment, permits the implementation of communications to the GSM or other (GPRS, UMTS, etc.) standards.

An embodiment of the invention provides such a technique which, in one specific embodiment, does not lead to a major or complex modification of the current radio-communication devices.

Even though the invention has been described in relation to a limited number of embodiments, a person skilled in the art would understand, upon reading this description, that other embodiments could be imagined without this leaving the scope of the invention.

1. Radio-communication module comprising:
transmission means with a first communication mode in at least one frequency band;
interference detection means of said module, permitting an alarm signal to be sent if interference is detected;
means of controlling said transmission means, permitting to switch from said first mode to a second communication mode that is distinct from the first mode, if said interference detection means supply said alarm signal.

2. Radio-communication module of claim 1, wherein said second communication mode uses at least one second frequency band that is distinct from said at least one first band.

3. Radio-communication module of, claim 1, wherein said at least one band is a GSM band 880.2-914.8 MHz, and said at lest one second band is an ISM band 915-925 MHz.

4. Radio-communication module of claim 1, wherein the first communication mode is compliant with a radio-communication standard belonging to the group comprising GSM, GPRS, UMTS, WCDMA, WiFi and Bluetooth.

5. Radio-communication module of claim 1, wherein the second communication mode implements a modulation technique belonging to the group comprising:
digital modulation techniques of the OOK type;
digital modulation techniques of the FSK type.

6. Radio-communication module of claim 1, wherein said transmission means comprise an amplifier which receives an input signal, supplies an output signal and is controlled by a command signal, and in said second communication mode, the input signal is a non-modulated signal and the command signal is a binary modulation signal, whose upper and lower levels respectively permit activation and deactivation of the amplifier, or inversely, such that the output signal is a signal modulated by a digital OOK modulation technique.

7. Radio-communication module of claim 6, wherein said transmission means comprise a switch between the amplifier and an antenna, and wherein in said second communication mode, the switch is controlled by said command signal so that the antenna only receives the output signal from the amplifier if the amplifier is activated by said command signal.

8. Radio-communication module of claim 1, wherein said control means comprise digital processing means and memory means, containing data to control and command said digital processing means, according to said first communication mode and according to said second communication mode.

9. Radio-communication module of claim 1, wherein said control means further permit to switch from said second to first communication mode in the case of the verification of at least one condition belonging to group comprising:
a detection by said detection means of an end of interference of said module;
a predetermined time has passed since detection of interference of said module;
an end of alarm signal is received via first reception means, which operate with said module or are incorporated into said module.

10. Radio-communication module of claim 9, wherein said interference detection means comprise second means for receiving an activation signal from said first reception means, which operate with said module or are incorporated into said module

11. Radio-communication module of claim 1, wherein said radio-communication module is designed to be mounted inside a vehicle, and said second communication mode is used to transmit information permitting said vehicle to be identified and/or located via a vehicle tracking network.

12. A method comprising:
providing a radio-communication module mounted inside a vehicle, wherein said radio-communication module comprises:
a transmitter with a first communication mode in at least one frequency band;
an interference detector, permitting an alarm signal to be sent if interference is detected; and
a controller controlling said transmitter to switch from said first mode to a second communication mode that is distinct from the first mode, if said interference detector supplies said alarm signal; and
using said second communication mode to transmit information permitting said vehicle to be identified and/or located via a vehicle tracking network.

13. Radio-communication device comprising:
at least one radio-communication module comprising:
transmission means with a first communication mode in at least one first frequency band;
interference detection means of said module, permitting an alarm signal to be sent if interference is detected;
means of controlling said transmission means, permitting to switch from said first mode to a second communication mode that is distinct from the first mode, if said interference detection means supply said alarm signal.
